(19) United States
(12) Patent Application Publication
(10) Pub. No.: US 2017/0259101 A1
(43) Pub. Date: Sep. 14, 2017

(54) HIGH BAR ASSEMBLY ATTACHABLE TO DOOR FRAME

(71) Applicant: Jae Hwan IM, Incheon (KR)

(72) Inventor: Jae Hwan IM, Incheon (KR)

(21) Appl. No.: 15/379,234

(22) Filed: Dec. 14, 2016

(30) Foreign Application Priority Data
Mar. 10, 2016 (KR) 10-2016-0028882

(51) Int. Cl. A63B 1/00; A63B 23/12; A63B 69/20; E06B 7/28

(52) U.S. Cl. CPC A63B 1/00; E06B 7/28; A63B 23/1218; A63B 69/201; A63B 69/206

(57) ABSTRACT

There is provided a high bar assembly attachable to a door frame, the assembly comprising: first and second door frame attachments secured to a door frame, wherein first and second door frame attachments are secured to first and second opposite inner side walls of the door frame respectively; first and second retainers protruding inwardly from the first and second door frame attachments in a monolithic or integrated manner therewith respectively; first and second bar supports retained or supported by the first and second retainers, wherein each bar support has a retainer groove in a first end thereof, wherein each retainer is slidably and removably fitted with each retainer groove in a horizontal direction, wherein each bar support is secured to each door frame attachment, wherein the second end of each support bar protrudes horizontally beyond the door frame by a predetermined distance; and an elongate bar passing through the second ends of the first and second bar supports.

### CROSS-REFERENCE TO RELATED APPLICATION

This application claims the benefit of Korea patent application No. 10-2016-0028882 filed on Mar. 10, 2016, the entire content of which is incorporated herein by reference for all purposes as if fully set forth herein.

### BACKGROUND

Field of the Present Disclosure

The present disclosure relates to a high bar assembly attachable to a door frame, and, more particularly, to a high bar assembly attachable to a door frame wherein the door frame may not interfere with the movement of the user.

Discussion of Related Art

In recent years, a need for a healthy life has increased, and, thus, a home exercise apparatus has been popularized as a fitness apparatus. As an example of such exercise apparatus, a high bar attachable to a doorframe is widely used.

Such a high bar is constructed by horizontally fixing the iron bar on the left and right upper and lower side walls of the door frame and is used as various exercise devices. However, since the iron bar is installed inside the door frame, the movement space is limited to the inside of the door frame, so that the user's head or arm may hit the top or side of the door frame. In order to solve the problem, Korean Patent No. 10-1322472 discloses a pull-up bar exercise device provided to be easily installed on a doorway pull-up bar that has been already installed in a door frame, not occupying a wide space for installation, for allowing a user to exercise on a higher and wider pull-up bar, thereby enabling the user to exercise in a safe and correct posture. This pull-up bar exercise device comprises a plurality of hanger parts which is bent at a predetermined angle in order to be hung on a pull-up bar that has been already installed in a door frame; a connection part which is extended from each of the plurality of hanger parts; an exercise bar which is extended from the connection part and protruded to both sides; and a support bar which is extended from the connection part and protruded to both sides. The pull-up bar exercise device is installed by hanging the plurality of hanger parts on the pull-up bar installed in the door frame and supporting the front of the door frame by the support bar, so that a user exercised on the exercise bar.

However, for this pull-up bar exercise device, when forces in certain directions may be applied to the bar, the device may be movable. Thus, the user's movement may be unstable.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The present disclosure is to provide a high bar assembly attachable to a door frame wherein an elongate bar is located out of a space defined between both side walls of the door frame and, thus, the door frame may not interfere with the movement of the user.

The present disclosure is to provide a high bar assembly attachable to a door frame wherein the elongate bar may be easily removed from or attached to the door frame.

The present disclosure is to provide a high bar assembly attachable to a door frame wherein when forces in all directions may be applied to the bar, the bar assembly may be immovable. Thus, the user's exercise may be stable.

In one aspect of the present disclosure, there is provided a high bar assembly attachable to a door frame, the assembly comprising: first and second door frame attachments secured to a door frame, wherein first and second door frame attachments are secured to first and second opposite inner side walls of the door frame respectively; first and second retainers protruding inwardly from the first and second door frame attachments in a monolithic or integrated manner therewith respectively; first and second bar supports retained or supported by the first and second retainers, wherein each bar support horizontally extends in a perpendicular manner to the inner side wall of the door frame, wherein each bar support has opposite first and second horizontal ends, wherein each bar support has a retainer groove in the first end thereof, wherein each retainer is slidably and removably fitted with each retainer groove in a horizontal direction, wherein each bar support is secured to each door frame attachment, wherein when each retainer has been completely fitted with each retainer groove, the second end of each support bar protrudes horizontally beyond the door frame by a predetermined distance; and an elongate bar passing through the second ends of the first and second bar supports.

In one implementation, each retainer has top and bottom linear faces, wherein each retainer groove has top and bottom linear faces, wherein the top and bottom linear faces of the retainer face-contact and correspond to the top and bottom linear faces of the groove respectively.

In one implementation, each support bar is secured, at the first end thereof, to each door frame attachment via a fastener.

In one implementation, the first and second frame attachments are coupled via first and second L shaped extensions to the first and second opposite inner side walls of the door frame, wherein each L shaped extension is secured via a fastener to the door frame, wherein each L shaped extension has a vertical portion secured to the inner side wall of the frame and a horizontal portion secured to an inner top wall of the frame.

In one implementation, each bar support tapers towards the second end thereof.

In one implementation, each bar support has first upper and lower L shaped protrusions protruding from the first end of the bar support, wherein between the first upper and lower L shaped protrusions, the retainer groove is defined.

In one implementation, each door frame attachment has second upper and lower L shaped protrusions protruding from an end thereof opposite the other end thereof facing the bar, wherein the second upper and lower L shaped protrusions are positioned such that when the retainer groove has completely been fitted with the retainer, the second upper and lower L shaped protrusions are juxtaposed with the first upper and lower L shaped protrusions respectively.

In one implementation, the juxtaposition between the first upper L shaped protrusion and the second upper L shaped protrusion define a upper upward-opened joint groove, and the juxtaposition between the first lower L shaped protrusion and the second lower L shaped protrusion define a lower upward-opened joint groove.

In one implementation, wherein an upper joint holder is fitted with the juxtaposition between the first upper L shaped protrusion and the second upper L shaped protrusion such that a downward-opened groove defined in the upper joint holder is fitted with the upper upward-opened joint groove, wherein a lower joint holder is fitted with the juxtaposition between the first lower L shaped protrusion and the second lower L shaped protrusion such that a downward-opened groove defined in the lower joint holder is fitted with the lower upward-opened joint groove.

In one implementation, wherein each retainer 20 has a central groove defined therein, wherein between the first and second retainers, a further elongate bar is arranged such that both ends of the further elongate bar are fitted into both central grooves of the first and second retainer.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a perspective view of a high bar assembly attachable to a door frame in accordance with one embodiment of the present disclosure.

FIG. 2 is an enlarged view of a left potion of the high bar assembly attachable to a door frame in FIG. 1 in accordance with one embodiment of the present disclosure.

FIG. 3 is an enlarged view of a state where the high bar assembly is detached from a door frame.

FIG. 4 is an enlarged view of a state where a bar support is separated from a door frame attachment in accordance with one embodiment of the present disclosure.

FIG. 5 is an enlarged view of a state where the bar support is coupled to the door frame attachment in FIG. 4.

FIG. 6 is an enlarged view of a state where a door frame attachment is coupled to a L shaped extension in accordance with one embodiment of the present disclosure.

FIG. 7 is one example of an application of a high bar assembly attachable to a door frame in accordance with one embodiment of the present disclosure.

FIG. 8 is a three-dimensional view of a door frame attachment having a retainer integrated therewith.

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

### DETAILED DESCRIPTIONS

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

Further, the use of “may” when describing embodiments of the present disclosure refers to “one or more embodiments of the present disclosure.”

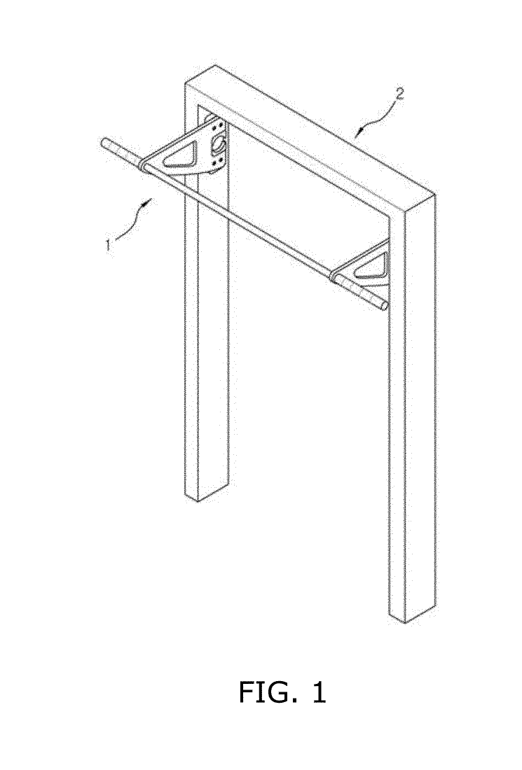

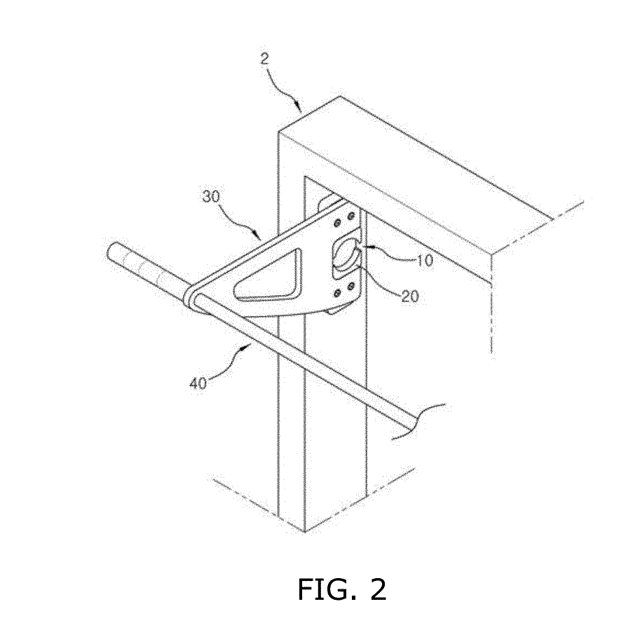

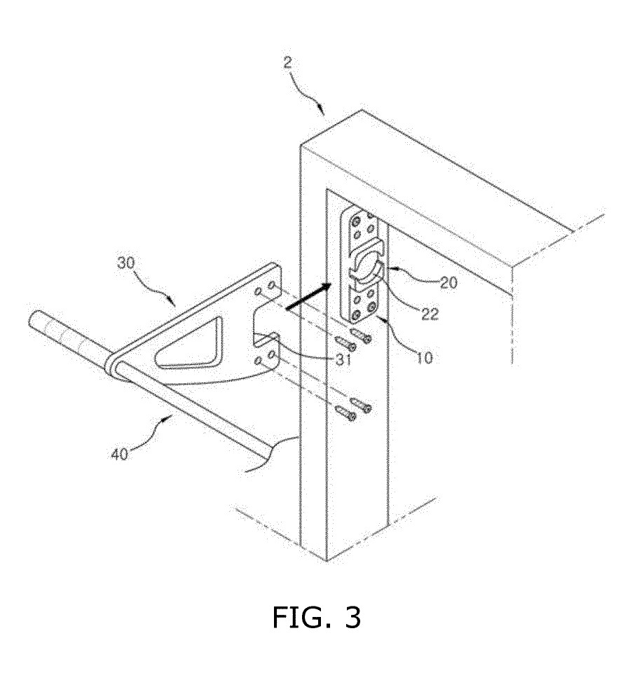

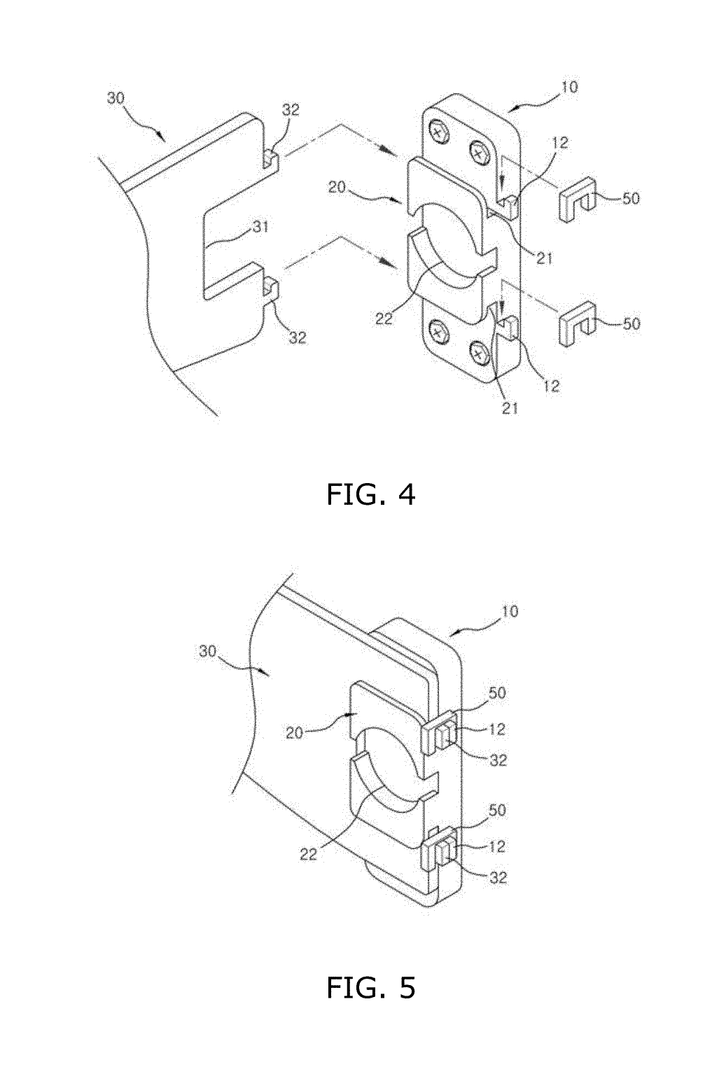

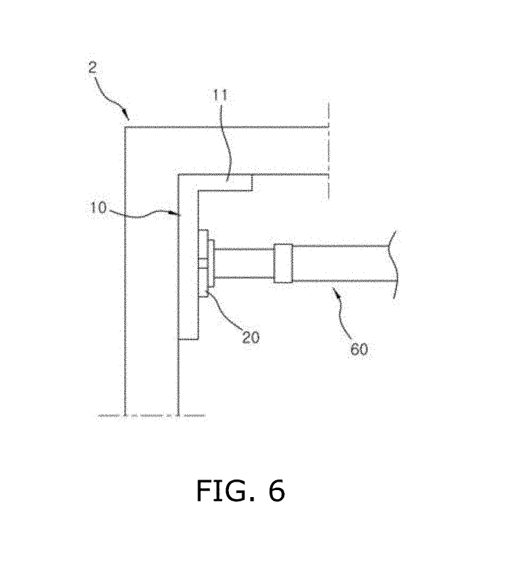

FIG. 1 is a perspective view of a high bar assembly attachable to a door frame in accordance with one embodiment of the present disclosure. FIG. 2 is an enlarged view of a left potion of the high bar assembly attachable to a door frame in FIG. 1 in accordance with one embodiment of the present disclosure. FIG. 3 is an enlarged view of a state where the high bar assembly is detached from a door frame. FIG. 4 is an enlarged view of a state where a bar support is separated from a door frame attachment in accordance with one embodiment of the present disclosure. FIG. 5 is an enlarged view of a state where the bar support is coupled to the door frame attachment in FIG. 4. FIG. 6 is an enlarged view of a state where a door frame attachment is coupled to a L shaped extension in accordance with one embodiment of the present disclosure.

The high bar assembly 1 attachable to a door frame 2 in accordance with one embodiment of the present disclosure may include a door frame attachment 10, a retainer 20, a bar support 30, and an elongate bar 40.

The door frame attachment 10 may be secured to the door frame 2.

Such a door frame attachment 10 may be secured to the door frame 2 at both opposite inner side walls thereof. In one example, the door frame attachment 10 may be secured via a fastener such as a bolt, a nail, etc. to the door frame 2 at both opposite inner side walls thereof.

In one embodiment, the door frame attachment 10 may be coupled via a L shaped extension 11 to the door frame 2 at both opposite inner side walls thereof, as shown in FIG. 6. The L shaped extension 11 may be secured to the door frame 2 at both opposite inner side and top walls thereof. In one example, the L shaped extension 11 may be secured via a fastener such as a bolt, a nail, etc. to the door frame 2 at both opposite inner side and top walls thereof. In other words, the L shaped extension 11 may have a vertical portion secured to the inner side wall of the frame 2 and a horizontal portion secured to the inner top wall of the frame 2. In this connection, each door frame attachment 10 may be secured to the vertical portion of the L shaped extension 11 via a fastener such as a bolt, a nail, etc.

Further, when the door frame 2 has a reinforcement protruding edge, the door frame attachment 10 may have an engaged groove (not shown) formed therein to be engaged with the reinforcement protruding edge.

The retainer 20 may protrude inwardly from the door frame attachment 10 in a monolithic or integrated manner. The retainer 20 may be configured to retain the bar support 30.

The retainer 20 may have top and bottom linear faces along which the bar support 30 slide and is engaged with the retainer 20.

The bar support 30 may be retained or supported by the retainer 20 and may support the elongate bar 40.

Left and right bar supports 30 may be coupled to each of the left and right door frame attachments 10. Each bar support 30 may have a groove 31 defined in the retainer side portion thereof. The groove 31 may have a shape corresponding to a contour of the retainer 20 integrated with the door frame attachment 10. In one example, the groove 31 may have top and bottom linear faces to slide along the top and bottom linear faces of the retainer 20 retainer when the groove 31 is fitted with the retainer 20.

Such a bar support 30 may have a horizontal length extending beyond the door frame 2 when the bar support 30 is fitted with the retainer 20.

In one embodiment as shown in FIG. 2 and FIG. 3, when the bar support 30 is fitted with the retainer 20, the bar support 30 may be secured to the door frame attachment 10 via a fastener such as a bolt, a nail, etc.

In one embodiment as shown in FIG. 4 and FIG. 5, the bar support 30 may be easily removably coupled to the door frame attachment 10. As shown in FIG. 4, the retainer 20 may have top and bottom sliding grooves 21 defined in a horizontal direction of the retainer such that the top and bottom faces of the groove 31 of the bar support 30 may be slidably inserted into the top and bottom sliding grooves 21 respectively.

Further, the bar support 30 may have first upper and lower L shaped protrusions 32 protruding from the retainer side end of the bar support 30. Between the first upper and lower L shaped protrusions 32, the groove 31 may be defined.

Furthermore, the door frame attachment 10 may have second upper and lower L shaped protrusions 12 protruding from the rear end thereof. Between the second upper and lower L shaped protrusions 12, the retainer 20 may be formed. The second upper and lower L shaped protrusions 12 may be positioned such that when the groove 31 has completely been fitted with the retainer 20, the second upper and lower L shaped protrusions 12 may be at the same level with or flush with the first upper and lower L shaped protrusions 32 respectively.

When the groove 31 has completely been fitted with the retainer 20, and thus, the second upper and lower L shaped protrusions 12 are at the same level with or flush with the first upper and lower L shaped protrusions 32 respectively, that is, the second upper and lower L shaped protrusions 12 are juxtaposed with the first upper and lower L shaped protrusions 32 respectively, the juxtaposition between the first upper L shaped protrusion 32 and the second upper L shaped protrusion 12 may define a upper upward-opened joint groove while the juxtaposition between the first lower L shaped protrusion 32 and the second lower L shaped protrusion 12 may define a lower upward-opened joint groove.

Thus, an upper joint holder 50 may be fitted with the juxtaposition between the first upper L shaped protrusion 32 and the second upper L shaped protrusion 12 such that a downward-opened groove defined in the upper joint holder 50 is fitted with the upper upward-opened joint groove. Thus, the bar support 30 may be firmly secured to the door frame attachment 10.

Likewise, a lower joint holder 50 may be fitted with the juxtaposition between the first lower L shaped protrusion 32 and the second lower L shaped protrusion 12 such that a downward-opened groove defined in the lower joint holder 50 is fitted with the lower upward-opened joint groove. Thus, the bar support 30 may be firmly secured to the door frame attachment 10.

In order to remove the bar support 30 from the door frame attachment 10, the upper joint holder 50 may be removed from the juxtaposition between the first upper L shaped protrusion 32 and the second upper L shaped protrusion 12. Further, the lower joint holder 50 may be removed from the juxtaposition between the first lower L shaped protrusion 32 and the second lower L shaped protrusion 12. Then, the bar support 30 may be pulled back from the door frame attachment 10 while the top and bottom faces of the groove 31 of the bar support 30 are slidably retracted from the top and bottom sliding grooves 21 respectively.

Each of the left and right bar supports 30 may have a bar through-hole defined in the front side end thereof. Thus, the elongate bar 40 may pass through the left and right bar through-holes of the left and right bar supports 30.

In one embodiment, the elongate bar 40 may have a fixed length. In one embodiment, the elongate bar 40 may have a variable length. In one example, the elongate bar 40 may be embodied as a multi-step pipe.

As described above, the bar support 30 may have a horizontal length extending in a front direction beyond the door frame 2 when the groove 31 has been completely fitted with the retainer 20. Thus, the elongate bar 40 coupled to the left and right bar supports 30 may be arranged in a front of the door frame 2 at a predetermined distance from the door frame 2. In this way, without the space limitation, the user may utilize the elongate bar 40 in various ways.

The present high bar assembly attachable to a door frame may have the retainer 20 having a central groove 22 defined therein. Thus, between the left and right retainers 20, a further elongate bar 60 apart from the elongate bar 40 may be arranged as shown in FIG. 6. Thus, the further elongate bar 60 may be arranged between the inner side walls of the door frame 2 while being located in the inner space defined between the inner side walls of the door frame 2. However, the elongate bar 40 may be arranged between the inner side walls of the door frame 2 while being located out of the inner space defined between the inner side walls of the door frame 2.

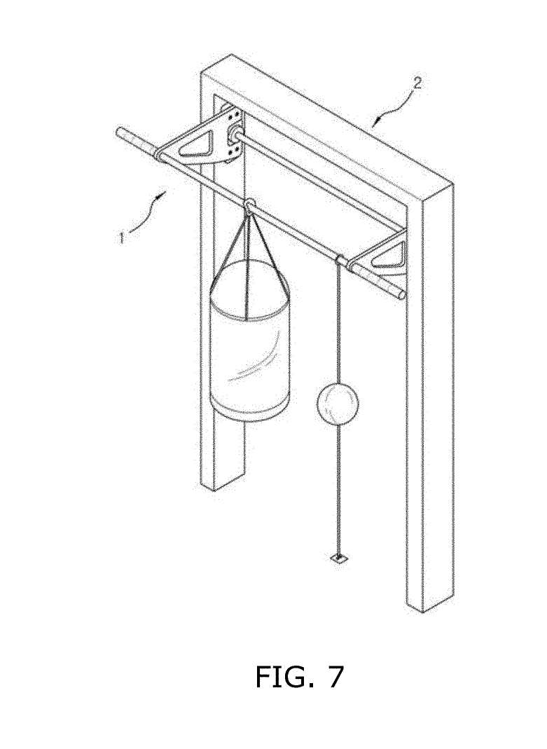

FIG. 7 is one example of an application of a high bar assembly attachable to a door frame in accordance with one embodiment of the present disclosure. The high bar assembly 1 attachable to a door frame in accordance with one embodiment of the present disclosure may be used in itself. Further, the high bar assembly 1 attachable to a door frame in accordance with one embodiment of the present disclosure may be used in a combination with another exercise devices such as a sandbag, a balloon, etc.

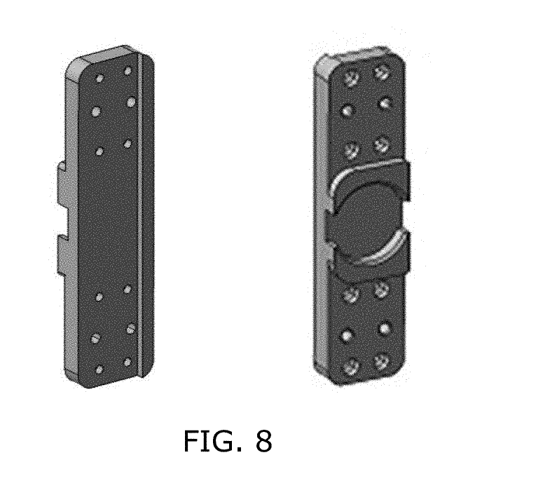

FIG. 8 is a three-dimensional view of a door frame attachment having a retainer integrated therewith. A right view thereof shows a rear portion of the door frame attachment. A left view thereof shows a front portion of the door frame attachment on which the retainer to retain the bar support is formed.

The above description is not to be taken in a limiting sense, but is made merely for the purpose of describing the general principles of exemplary embodiments, and many additional embodiments of this disclosure are possible. It is understood that no limitation of the scope of the disclosure is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

What is claimed is:

1. A high bar assembly attachable to a door frame, the assembly comprising:
first and second door frame attachments secured to a door frame, wherein first and second door frame attachments are secured to first and second opposite inner side walls of the door frame respectively;
first and second retainers protruding inwardly from the first and second door frame attachments in a monolithic or integrated manner therewith respectively;
first and second bar supports retained or supported by the first and second retainers, wherein each bar support horizontally extends in a perpendicular manner to the inner side wall of the door frame, wherein each bar support has opposite first and second horizontal ends, wherein each bar support has a retainer groove in the first end thereof, wherein each retainer is slidably and removably fitted with each retainer groove in a horizontal direction, wherein each bar support is secured to each door frame attachment, wherein when each retainer has been completely fitted with each retainer groove, the second end of each support bar protrudes horizontally beyond the door frame by a predetermined distance; and
an elongate bar passing through the second ends of the first and second bar supports.

2. The assembly of claim 1, wherein each retainer has top and bottom linear faces, wherein each retainer groove has top and bottom linear faces, wherein the top and bottom linear faces of the retainer face-contact and correspond to the top and bottom linear faces of the groove respectively.

3. The assembly of claim 1, wherein each support bar is secured, at the first end thereof, to each door frame attachment via a fastener.

4. The assembly of claim 1, wherein the first and second frame attachments are coupled via first and second L shaped extensions to the first and second opposite inner side walls of the door frame, wherein each L shaped extension is secured via a fastener to the door frame, wherein each L shaped extension has a vertical portion secured to the inner side wall of the frame and a horizontal portion secured to an inner top wall of the frame.

5. The assembly of claim 1, wherein each bar support tapers towards the second end thereof.

6. The assembly of claim 1, wherein each bar support has first upper and lower L shaped protrusions protruding from the first end of the bar support, wherein between the first upper and lower L shaped protrusions, the retainer groove is defined.

7. The assembly of claim 6, wherein each door frame attachment has second upper and lower L shaped protrusions protruding from an end thereof opposite the other end thereof facing the bar, wherein the second upper and lower L shaped protrusions are positioned such that when the retainer groove has completely been fitted with the retainer, the second upper and lower L shaped protrusions are juxtaposed with the first upper and lower L shaped protrusions respectively.

8. The assembly of claim 7, wherein the juxtaposition between the first upper L shaped protrusion and the second upper L shaped protrusion define a upper upward-opened joint groove, and the juxtaposition between the first lower L shaped protrusion and the second lower L shaped protrusion define a lower upward-opened joint groove.

9. The assembly of claim 8, wherein an upper joint holder is fitted with the juxtaposition between the first upper L shaped protrusion and the second upper L shaped protrusion such that a downward-opened groove defined in the upper joint holder is fitted with the upper upward-opened joint groove, wherein a lower joint holder is fitted with the juxtaposition between the first lower L shaped protrusion and the second lower L shaped protrusion such that a downward-opened groove defined in the lower joint holder is fitted with the lower upward-opened joint groove.

10. The assembly of claim 1, wherein each retainer 20 has a central groove defined therein, wherein between the first and second retainers, a further elongate bar is arranged such that both ends of the further elongate bar are fitted into both central grooves of the first and second retainer.
